(19) United States
(12) Patent Application Publication
(10) Pub. No.: US 2014/0113200 A1
(43) Pub. Date: Apr. 24, 2014

(54) Functionalized Carbon Electrode, Related Material, Process for Production, and Use Thereof

(71) Applicant: Fraser Seymour, Middletown, MD (US)

(72) Inventor: Fraser Seymour, Middletown, MD (US)

(21) Appl. No.: 14/139,421

(22) Filed: Dec. 23, 2013

Related U.S. Application Data
(63) Continuation-in-part of application No. 13/190,006, filed on Jul. 25, 2011, now Pat. No. 8,614,878.
(60) Provisional application No. 61/756,508, filed on Jan. 25, 2013.

(51) Int. Cl. H01G 11/38; H01M 4/36

(52) U.S. Cl. CPC H01G 11/38; H01M 4/366
USPC 429/231.8; 361/502

(57) ABSTRACT

The present invention relates to a material for use as an electrode for electrochemical energy storage devices such as electrochemical capacitors (ECs) and secondary batteries, primary batteries, metal/air batteries, fuel cells, flow batteries and a method for producing the same. More specifically, this invention relates to an electrode material consisting of a functionalized porous carbon, a method for producing the same, and an energy storage device using said electrode materials.

### CROSS-REFERENCE TO RELATED APPLICATIONS

This application is a continuation-in-part of U.S. applications identified by application No. 61/756,508 filed on Jan. 25, 2013, by application Ser. No. 13/190,006 filed on Jul. 25, 2011, and claims priority thereto; the foregoing applications being incorporated herein by reference.

### FIELD OF THE INVENTION

The present invention relates to a material for use as an electrode for electrochemical energy storage devices such as electrochemical capacitors (ECs) and secondary batteries, primary batteries, metal/air batteries, fuel cells, flow batteries and a method for producing the same. More specifically, this invention relates to an electrode material consisting of a functionalized porous carbon, a method for producing the same, and an energy storage device using said electrode materials.

### BACKGROUND OF THE INVENTION

Electrochemical capacitors (EC, sometimes referred to in the art as ultra-capacitors, super-capacitors or pseudo-capacitors) are energy storage devices generally characterized by the ability to charge and discharge at equivalent rates (rate symmetry) and exhibit a near-proportional relationship between state of charge and voltage (potential/charge proportionality). ECs also exhibit more rapid charge/discharge rates, greater energy efficiency and longer cycle life versus rechargeable (secondary) batteries, for example.

A typical EC cell comprises a pair of electrodes, a separator that is an ionic conductor but an electronic insulator placed between these electrodes; all of these components infused with electrolyte that contains and conducts ions to facilitate charge storage at the electrodes. Electrodes are typically fabricated as films formed from a paste comprising powdered active material, binder and conductivity-enhancing carbon powder, and adhered to an electrically conductive current-collector material. Typical electrolytes comprise salts of alkali metals or alkaline earth metals in liquid solvents, but may alternatively be ionic liquids. Non-liquid forms of electrolytes include solid or gel polymers or solid ceramic, for example.

ECs typically store charge at or near the interface between the electrolyte and the electrode material, thus permitting the aforementioned performance characteristics. They typically use electrostatic ion adsorption (electric double-layer), surface faradaic pseudo-capacitance, or bulk intercalation systems for charge storage. EC devices that rely exclusively on ion adsorption for charge storage in both positive and negative electrodes are referred to as electric double layer capacitors (EDLCs). EDLCs utilize symmetric electrodes typically comprising activated carbon (AC) or other carbon exhibiting large specific surface area as the active material. EC devices that use an electric double layer electrode and a pseudo-capacitive or intercalation electrode are referred to as asymmetric ECs. For example, the so-called lithium-ion capacitor (LIC) is a form of asymmetric EC that uses intercalation-based anode materials such as hard carbon, graphite or lithium titanate with a carbon material providing electric double layer charge storage for the cathode.

The amount of charge stored by ion adsorption is related to the interfacial surface area of the electrode active material which is accessible by the electrolyte ions. Activated carbon electrodes, for example, typically have specific surface areas between 1000 and 3000 m²/g achieved with a high concentration of micropores (pore diameter less than 2 nm) and ultra-micropores (pore diameter less than 0.7 nm) for the larger specific surface area carbons. In general, specific surface area is inversely related to pore size.

Commercial activated carbon powder is generally derived from a natural cellulose-based precursor such as wood or coconut shell, for example. These types of activated carbons suffer from a number of limitations: a) the smallest of the pores are not accessible to the ionic species in the electrolyte, and therefore do not contribute charge storage capacity; b) the pore size distribution of AC tends to not be hierarchical and thus does not provide electrolyte reservoirs within the electrode, which limits available storage capacity at high charge/discharge rates; c) the tortuous pore structure is not through-connected so the transport of electrolyte ions and evolved gas species is impeded; d) low apparent density limits volumetric energy; e) the activation involves an additional step in the manufacturing process which increases cost; f) the activation process itself decreases carbon yield, thereby further increasing materials cost; and g) these materials and methods do not inherently permit a means to dope the carbon matrix.

In an effort to address these limitations, a number of alternative carbon precursors and synthesis methods have been investigated: a) Pekala et al. pyrolized/activated resorcinol/formaldehyde 3-D polymer aerogels (U.S. Pat. No. 5,476,878 A); b) carbide-derived carbons; and c) carbons formed from various carbon precursors whose pore structures are formed with template approaches including organic “soft” template, and “hard” templates using zeolyte or silica materials. The materials and synthesis costs of these approaches are very high, however.

More recently, M. Inagaki, H. Konno, T. Morishita et al. (non-patent publication “Carbon 48 (2010) 2690-2707”) used magnesium oxide and various magnesium-containing compounds as template materials. This approach has provides resulting carbon with controlled features while also providing the advantage a low cost, recyclable template media. G. Yang et al. (non-patent publication “Carbon 50 (2012) 3753-3765”) have used calcium carbonate in similar fashion. These works generally focus on carbon structure as opposed to functionalization, however.

Surface-area normalized capacitance (farads/cm² or simply F/cm² of the electrode), is a metric used to quantify the double-layer electrode charge storage. The theoretical upper limit for activated carbon, for example, is ca. 25 uF/cm², but practical values range from ca. 6.5-8 uF/cm² to ca. 10-15 uF/cm² for aprotic and aqueous electrolytes respectively. The difference between theoretical and practically realized capacitance is due to inaccessibility of electrolyte (solvated) ions to the electrode's smallest, more tortuous or blocked pores.

Pseudo-capacitance involves charge transfer through rapid oxidation/reduction (redox) reactions occurring at or near the surface of the electrode active material over a potential (voltage) range and with a current vs. voltage response similar to that of the EDLC. Materials capable of providing pseudo-capacitive behavior include doped carbon, conductive polymers, transition metal oxides and transition metal hexacyanometalates.

According to Colliex et al., carbon may be doped or otherwise augmented with heteroatoms (see non-patent publication “Science Vol. 266 9 Dec. 1994”). Such doping results in related functional groups that induce pseudo-capacitive behavior. According to Frackowiak et al. (see non-patent publication “Chemical Physics Letters 404 (2005) 53-58”), Pseudo-capacitive inducing heteroatoms include oxygen as an electron receptor and nitrogen as an electron donor, for example. Other behavioral modifications possible through functionalization include the alteration of hydrophobicity and electronic conductivity (nitrogen or graphitic carbon), irreversible oxidation, and the gas evolution potential of the electrode material (phosphorous). In another example, Pekala et al. envisioned a resorcinol/formaldehyde aerogel doped with one or more of phosphorous, boron, arsenic and antimony (U.S. Pat. No. 5,358,802).

Other materials exhibiting pseudo-capacitive behavior include electro-active polymers such as polypyrrole, polyaniline, polythiophene, for example; oxides of transition metals such as manganese, cobalt, lead or nickel; or transition metal hexacyanometalates including metal hexacyanoferrates, metal hexacyanotitanates, metal hexacyanocobaltates, or metal hexacyanomanganates for example.

Low cost, plentiful transition metal oxides such as manganese oxide, nickel oxide and others have been investigated and in some cases commercialized. The specific capacitance of these materials ranges from approximately 200 F/g for powder/paste derived thick films (tens of microns to hundreds of microns) to more than 500 F/g for very thin planar films of less than 100 nanometers. This difference in capacitance (and ultimately energy density) demonstrates the surface nature of the pseudocapacitance charge storage mechanism. However, power density also is limited by the surface nature of pseudocapacitance as the longer ion diffusion length of thicker material serves to reduce reaction rate. The power density of electrodes using these oxides is further limited by the very low intrinsic electronic conductivity of these materials.

U.S. Pat. No. 6,339,528 discloses the synthesis of an amorphous manganese oxide on a non-structural carbon (i.e. carbon powder), which is then ground to form a paste used with a binder to form an electrode. Others have suggested similarly coating loose, non-structured carbon nanotubes with amorphous manganese oxide subsequently mixing the coated nanotubes with a binder to form an EC electrode. While each of these approaches offer improved rate performance resulting from the reduced ion diffusion length vs. oxide powder based paste electrodes, they do not resolve the underlying problems associated with electronic conductivity and electrolyte accessibility.

Long et al. (see for example, 20080247118; 20080248192; and 20100176767) have proposed an approach for addressing these shortcomings by applying a very thin coating of poorly crystalline MnO₂ or iron oxide to a carbon structure. In doing so, the high capacitance and fast reaction rate of the thin film approach is preserved. Further, the 3-dimensional carbon structure provides a low (electronic) resistance path to the current collector and an open porosity providing much improved electrolyte ion access to the MnO₂ or iron oxide active material. The synthesis approach suggested by Long involves the reduction of permanganate or potassium ferrate(VI) on the surface of the carbon. This takes place as the coating is deposited utilizing the carbon as a sacrificial reductant to synthesize the oxide. The oxide deposition method suggested by Long results in a conformal coating of the carbon structure.

Long's approach describes the use of a monolithic carbon structure “nanofoam” comprising a resorcinol/formaldehyde polymer derived aerogel supported by a paper further comprising carbon microfibers formed by pyrolysis of PAN microfibers. Long's approach precludes the use of carbon powders which, while providing the benefits of 3-dimensional carbon structures, do not comprise a rigid monolithic electrode.

While Long's approach does improve many of the shortcomings of the oxide as an EC electrode active material, it is limited to the formation of a MnO₂ or iron oxide only film. Popov et al. with the University of South Carolina demonstrated a 10% improvement in operating voltage range and a 25% increase in capacity vs. a manganese-only approach. This was accomplished by creating an oxide mixture comprising manganese and either lead oxide or nickel oxide, the latter leading to these aforementioned improvements. Popov did not utilize a carbon structure but rather created a mixed oxide powder through Sol-Gel techniques, these powders with a binding agent and conductivity enhancing carbon to create a paste electrode.

With U.S. Pat. Nos. 7,986,509, 8,493,711 and 8,503,162, Seymour discloses an electrode material created by forming a thin conformal coating of one or more metal oxides on a porous carbon structures; however, the carbon form is limited to a composite comprising a polymer-derived aerogel and one or more additional pre-formed carbon. Also, the active material is limited to one or more metal oxides.

With U.S. Pat. No. 8,614,878, Seymour discloses an electrode material created by forming a thin conformal coating of one or more metal oxides on a carbon powder; however, the carbon is limited and the active material is limited to one or more metal oxides.

While the previously discussed improvements in technology are highly significant, there remains a need in the art for EC devices and therefore electrodes having improved cycle life stability, expanded operating voltage range, increased the storage capacity and improved power density while also providing low cost.

Lithium ion secondary batteries operate through the intercalation/de-intercalation of lithium ions into and out of the solid bulk electrode materials. Today's lithium ion electrode materials typically comprise a graphite-based anode and a transition metal oxide (typically cobalt, nickel or manganese) cathode. During the charging cycle, electrons are removed from the cathode, which causes charge-compensating lithium ions to be released into the electrolyte where they migrate towards the anode; while electrons are simultaneously added to the anode causing lithium ions to be inserted into the anode. The opposite occurs during discharge.

The fabrication method of these electrodes relies on powdered active materials formed into a paste including binder material and (electronic) conductivity enhancing carbon. The thickness of these cathodes ranges from 30 micrometers for high power (low energy) batteries to 200 micrometers for high-energy (low power) versions. Typical oxide powder particle sizes vary from hundreds of nanometers to a few micrometers in diameter. Lithium ions penetrate these macroscopic cathode structures through the electrolyte and subsequently diffuse as much as a few microns into the bulk oxide particle. The charge-compensating electrons from the oxide must then traverse the low-conductivity oxide and electrolyte to complete the circuit.

Ion diffusion into the solid-state electrode particles induces mechanical stress on the oxide crystal lattice as it expands to accommodate the ion insertion. These expansion/contraction cycles cause the eventual breakdown of the oxide limiting device cycle life. It is therefore preferable for the oxide vacancies to be of a size relative to the ion so as to allow ion diffusion with minimal expansion. For the same reason, it is also preferable for the diffusion to be as shallow as possible and to choose ion/oxide systems that exhibit minimal expansion.

While the previously discussed improvements in secondary battery technology are highly significant, there remains a need in the art for secondary battery devices and therefore secondary battery electrodes having improved cycle life, shorter recharge time and generally increased usable storage capacity at elevated power levels.

### SUMMARY OF THE INVENTION

It is an object of the present invention to provide an electrode material exhibiting a greater amount of energy stored per unit mass and per unit volume versus that of commercially available activated carbons.

It is another object of the present invention to provide an electrode material with the behavioral characteristics of fast charge rates or rate symmetry, excellent charge/discharge energy efficiency and excellent cycle life.

It is another object of the present invention to provide a method of manufacture for porous carbon material wherein the template material can be reconstituted and reused.

It is an advantage of the present invention that the electrode material provides low cost of raw materials and simple synthesis processing.

The aforementioned objects and advantages are satisfied by a porous carbon comprising at least one functionalizing agent, the incorporation of said functionalizing agent with said carbon material is one or more selected a group consisting of a dopant, a physical mixture composite carbon matrix, a deposit upon said carbon surface, or any combination thereof.

The electrode material not only is suitable as a material for EC and secondary batteries, but also may be used as primary battery electrodes, fuel cell electrodes, absorption electrodes in water de-ionization or gas purification, and as electrodes for electrolysis.

As used herein “substantially”, “generally”, “relatively”, “approximately”, and “about” are relative modifiers intended to indicate permissible variation from the characteristic so modified. It is not intended to be limited to the absolute value or characteristic, which it modifies but rather approaching or approximating such a physical or functional characteristic.

References to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

In the following description, reference is made to the accompanying drawings, which are shown by way of illustration to specific embodiments in which the invention may be practiced. The following illustrated embodiments are described in sufficient detail to enable those skilled in the art to practice the invention.

It is to be understood that other embodiments may be utilized and that structural changes based on presently known structural and/or functional equivalents may be made without departing from the scope of the invention.

Hereinafter, various embodiments of the present invention will be explained in more detail with reference to the accompanying figures; however, it is understood that the present invention should not be limited to the following preferred embodiments and such present invention may be practiced in ways other than those specifically described herein.

### BRIEF DESCRIPTION OF THE DRAWINGS

FIG. 1 shows a cross-sectional view of the coating on a porous carbon forming a film-functionalized electrode material. 1 represents bare carbon structure, 2 represents current collector and 3 represents oxide layer on the electrode carbon.

FIG. 2 shows a pseudocapacitive-type behavior in a cyclic voltammogram for Example 1; poorly crystalline nickel/manganese electrode material at 10 mv/S in 1M LiCl.

FIG. 3 shows a constitutional drawing of an electrochemical cell such as an EC or secondary battery. 1 represents the cathode current collector, 2 represents the cathode, 3 represents the electrolyte/separator, 4 represents the anode and 5 represents the anode current collector.

FIG. 4 shows a more classic insertion redox behavior in a cyclic voltammogram for Example 3; more crystalline oxide containing spinel phase electrode material at in 2M Li₂SO₄.

FIG. 5 shows a double-layer and pseudo-capacitance behavior in a cyclic voltammogram for Example 4; magnesium oxide templated, nitrogen and phosphorous doped carbon material at 5 mV/s in 4M ZnCl₂+3M NaCl electrolyte in a Zn/carbon cell.

FIG. 6 shows a double-layer and pseudo-capacitance behavior in a cyclic voltammogram for Example 5; magnesium oxide templated, nitrogen doped carbon material at 5 mV/s in 1M Na₂SO₄ electrolyte in a half-cell vs. Ag/AgCl reference.

### DETAILED DESCRIPTION OF THE INVENTION

The present invention is directed particularly towards a functionalized porous carbon material having a specific surface area greater than about 10 m²/g and less than about 3000 m²/g and the form of a powder or a monolith; the precursor materials for said functionalized carbon comprise at least one carbon-containing compound as a carbon source for synthesized carbon, at least one templating agent, and at least one functionality-inducing agent; wherein said functionality-inducing agent is incorporated in the form of one or more selected a group consisting of a dopant, a physical mixture forming a composite matrix of said synthesized carbon, a deposit upon said carbon surface, or any combination thereof.

The precursor source material for said synthesized carbon is at least one selected from a group consisting of an aromatic hydrocarbon, a hydrolyzed benzene, an amine, an aniline, an aldehyde, a dialdehyde, a gelatin compound, a monosaccharide, a disaccharide, a oligosaccharide, a polysaccharide, and a thermoplastic polymer.

Said templating agent is at least one compound selected from a group comprising metal-containing compounds wherein each comprises a metal A and material B, or a combination of metal A, material B and at least one cation species, wherein metal A is selected from a group of consisting of ions of the elements magnesium (Mg), calcium (Ca), sodium (Na), potassium (K), lithium (Li), manganese (Mn), nickel (Ni), cobalt (Co), iron (Fe), aluminum (Al), chromium (Cr), molybdenum (Mo), vanadium (V), tungsten (W), tantalum (Ta), lead (Pb), tin (Sn), titanium (Ti), copper (Cu), zinc (Zn), niobium (Nb), silicon (Si) and any combination thereof wherein material B comprises at least one selected from a group consisting of oxygen (O), hydrogen (H), nitrogen (N), phosphorous (P), sulfur (S), carbon (C), fluorine (F) and any combination thereof.

Example templating agent anion species include the inorganic anions nitrate, sulfate, phosphate and chloride. Example templating agent anion species also include the organic anions citrate, acetate, carbonate and gluconate.

Said dopant comprises at least one P-block element selected from a group consisting of N, O, F, Si, P, S, boron (B), chlorine (Cl), gallium (Ga), germanium (Ge), selenium (Se), bromine (Br), and iodine (I).

Said functionalizing agent incorporated as a composite carbon physical mixture comprises at least one precursor material selected from a group consisting of i) a preformed carbon and ii) an inorganic compound; wherein said preformed carbon is at least one selected from a group containing carbon microfibers, carbon nanofibers, carbon nanotubes, carbon nanowires, graphene, reduced graphene oxide, graphite, and carbon black; wherein said inorganic compound contains material A and material B, or a combination of material A, material B and at least one cation species, wherein material A is selected from a group of consisting of Mn, Ni, Co, Fe, Al, Cr, Mo, V, W, Ta, Pb, Sn, Ti, Cu, Zn, Nb, Si, Na, K, Li, Mg, Ca, and any combination thereof, and material B is selected from a group of consisting of O, H, P, C, N, S and any combination thereof.

Said functionalizing agent incorporated as a surface deposit comprises at least one selected from a group comprising metal oxide, electro-active polymer, electro-active polymer which is doped with at least one inorganic species, and transition metal hexacyanometalate; wherein said metal oxide deposit contains material A and material B, or a combination of material A, material B and at least one cation species, or a combination of material A, material B and at least one cation species and water, wherein material A is at least one selected from a group of consisting of Mn, Ni, Co, Fe, Al, Cr, Mo, V, W, Ta, Pb, Sn, Ti, Cu, Zn, Nb, Si, Na, K, Li, Na, K, Mg, Ca, and any combination thereof, and material B is at least one selected from a group of consisting of O, H, P, C, N, S and any combination thereof; wherein said electro-active polymer comprises one or more of a redox polymer or a conductive polymer, said electro-active polymer is selected from a group consisting of polypyrrole (PPy), polyaniline (PANI), poly-3,4-ethylenedioxythiophene (PEDOT), poly(o-methoxyaniline) (POMA), poly-1,5-diaminoanthraquinone (PDAAQ), polyquinoxaline (PQ), polyindole (PIn), cyclic indole trimers (CIT), 5-carboxy CIT, 5-cyano CIT, polyacene (PAC), polyacetylene (PA), poly(vinylpyridine) (PVPy), tetramethylpyridine, polythiophene (PT), and derivatives and combinations thereof; wherein the dopant of said electro-active polymer is at least one element selected from a group consisting of O, H, P, C, N, S, Mn, Ni, Co, Fe, Al, Cr, Mo, V, W, Ta, Pb, Sn, Ti, Cu, Zn, Nb, Na, K, Mg, Ca, and Li; wherein said transition metal hexacyanometalate takes the form A^{va}ₐ (M₁^{v1})_{b} [M₂^{v2}(CN)_{c}]_{d}*xH₂O, where “A” is an insertion cation of valence “va” of an alkali metal, an alkaline earth metal or ammonium, where “M₁” is a metal ion of valence “v1”, where M₂ is a metal ion of valence “v2”, where “a”, “b”, “c”, and “d” represent stoichiometry of the complex, and where “x” represents the stoichiometry of coordinated water molecules, where M₁ is at least one element selected from a group consisting of Mn, Ni, Co, Fe, Al, Cr, Mo, V, W, Ta, Pb, Sn, Ti, Cu, Zn, and Nb, where M₂ is least one element selected from a group consisting of Mn, Ni, Co, Fe, Al, Cr, Mo, V, W, Ta, Pb, Sn, Ti, Cu, Zn, and Nb; wherein the average thickness of said surface deposit is greater than about 5 nanometers and less than about 1000 nanometers.

The present invention is a functionalized porous carbon, which is a material with macro or micron-scale dimensions with nano-scale features; essentially an extrapolation of nano-scale materials. One purpose of this form is to provide the surface access and diffusion benefits of nanomaterials with improved electronic transport of a micro or macro-scale structure.

Another purpose is to provide materials with these aforementioned characteristics in a size and form that is similar to typical capacitor or battery materials used by the industry already permitting the use of current manufacturing techniques that are compatible with current manufacturing equipment in ways nanoscale materials in and of themselves may not be. These electrode materials are for use in electrochemical energy storage devices including electrochemical capacitors, secondary batteries or other energy storage or energy conversion device and may be combined with additional materials such as binder and conductivity-enhancing carbon black. Such electrochemical capacitor or secondary battery includes for example an electrolyte, an electronically insulating but ionically conductive separator film, a pair of electrodes or in the case of a device using electrodeposition and dissolution processes as anode functionality, an electrode and an anode deposition substrate (ADS) separated by said separator and electrolyte, each electrode or electrode/ADS combination is physically attached and electronically connected to a current collector, wherein at least one of said electrodes comprise the functionalized carbon as described herein as electrode active material. Said electrolyte comprises at least one cation species, at least one anion species, and comprises at least one composition selected from a group consisting of ionic liquid, salt and polymer, salt and ceramic, salt and liquid solvent and polymer as a gel, salt and liquid solvent and fumed silica as a gel, and salt and liquid solvent, wherein the liquid solvent comprises at least one selected from a group consisting of water and aprotic liquid. The second electrode, if not an functionalized carbon electrode material as defined herein, is selected from a group consisting of one or more electrodeposited metal; one or more metal oxides; one or more metal phosphates, one or more metal carbides; one or more metal nitrides; a composite carbonaceous paste comprising powder of one or more selected from a list consisting of activated carbon, carbon nanofibers, carbon nanotubes, graphene, reduced graphene oxide, graphite or any combination thereof, with binder and conductivity enhancing carbon; a composite carbonaceous paste comprising graphitic carbon powder, hard carbon powder, metal oxide/carbon composites, silicon/carbon composites or any combination thereof with binder and conductivity enhancing carbon; or a porous carbon structure. The current collector is selected from a group consisting of metal foil, graphite foil, metal mesh, electrically conductive polymer composites, expanded metal, or combinations thereof.

For embodiments wherein said electrolyte includes water as a solvent or co-solvent, said cathode carbon material is preferred to possess pores with average diameter greater than about 1 nm and an interconnected pore structure. These pore features promote transport of ionic species and also promote the transport of any evolved gas species. Further, in such an embodiment, said carbon is preferred to possess dopant heteroatoms to impart certain functionalities. In one exemplary embodiment, the presence of nitrogen functional groups within the carbon matrix and upon the carbon surface increases electronic conductivity and induces pseudo-capacitance respectively; the presence of oxygen functional groups induces pseudo-capacitance; the presence of phosphorous increases the overpotential to gas evolution. The presence of heteroatoms may provide the additional benefit of decreasing the occurrence of irreversible oxidation of said carbon material at elevated electrochemical potentials. Therefore, for embodiments employing such aqueous electrolytes, cathode carbon materials incorporating one or more dopant heteroatoms N, O, and P are preferred.

Heteroatom dopant precursor materials are of the general formula CₐH_{b}A_{c}O_{d} where “C” is a cation with stoichiometry “a” greater than or equal to 0 and less than or equal to 4, where “H” is hydrogen with stoichiometry “b” greater than or equal to 0 and less than or equal to 4, where “A” is dopant element anion component with stoichiometry “c” greater than or equal to 1 and less than or equal to 2, and “O” is oxygen with stoichiometry “d” greater than or equal to 1 and less than or equal to 8. Examples of these include acids HNO₃, H₂SO₄, H₃PO₄ and H₃BO₄ for N, S, P and B doping respectively, although they also affect O functional groups and impart an activation effect upon porous carbon made with these precursors. Also, some acids are available in liquid form only, limiting the synthesis method to liquid phase mixed precursors. Alternatively, other precursor compounds containing the appropriate dopant may be used. These include Mg(NO₃)₂, MgSO₄, Mg(H₂PO₄)₂, and MgB₄O₇ for N, S, P and B doping respectively, may be used with dry and liquid precursor mixing methods, and impart additional templating effects. Cation Mg is used here as an example; therefore, cation species is at least one selected from a group consisting of Mg, Na, K, Li, Mg, Ca, Mn, Ni, Co, Fe, Al, Cr, Mo, V, W, Ta, Pb, Sn, Ti, Cu, Zn, and Nb.

Examples of said carbon source precursors for the synthesized porous carbon include melamine, urea, polyacrylonitrile (PAN), hydroquinone, catechol, resorcinol, gelatin, agar, glucose, sucrose, fructose, aniline, nitrobenzene, chlorobenzene, benzene sulphonic acid, polypyrrole (PPy), PANI, PEDOT, POMA, PDAAQ, PQ, PIn, CIT, 5-carboxy CIT, 5-cyano CIT, PAC, PA, PVPy, tetramethylpyridine, PT, poly(ethylene terephthalate), polyimide, poly(vinyl alcohol) (PVA), coal tar pitch, poly carbonate, phenol, poly(vinylpyrrolidone) (PVP), polyacrylamide (PAA), trimethylolmelamine (TMM), polyvinylidene difluoride (PVDF) and polyvinylidene chloride (PVDC).

The precursor materials for said functionalized porous carbon may be admixed as dry powder or as wet powder or as wet paste or as a liquid phase solution or any combination of these in any sequence.

Said transition metal hexacyanometalate take the general form AₐM₁M₂(CN)₆ and in particular the copper hexacyanoferrate ACuFe(CN)₆ referred to hereinafter as “CuHCF” is a desirable metal hexacyanometalate compound as cathode material used in aqueous electrochemical energy storage devices. In this case, Fe is reduced from 3⁺ to 2⁺ valence upon insertion of cation A⁺.

Hereinafter, various embodiments of the present invention will be explained in more detail with reference to the accompanying figures; however, it is understood that the present invention should not be limited to the following preferred embodiments and such present invention may be practiced in ways other than those specifically described herein.

In one embodiment, the functionalized porous carbon electrode material comprises a functionalized porous carbon electrode material; heteroatom doped. Melamine is used as a source of carbon and to provide dopant nitrogen to increase electron conduction and induce pseudocapacitive functionality, magnesium phosphate is used to provide phosphorous dopant and additional templating, glucose-D is used as a carbon source to modify the relative concentration of carbon vs. dopants and to induce oxygen functional groups for pseudocapacitance, carbon black was used to induce improved electron conduction functionality. Magnesium citrate was used as a precursor to magnesium oxide formed during heating and used as a templating agent, to provide oxygen functionality for pseudocapacitance and as an additional source of carbon.

Precursor materials are combined, all in dry powder form and grind mixed to ensure mixture uniformity. The mixed precursors then heated to 700° C. under flowing nitrogen atmosphere, and held at that temperature, then cooled. Heating, dwell time and cooling rates are controlled. The resulting carbon is then rinsed with mild acid to remove magnesium oxide template thereby revealing dope-functionalized porous carbon. The porous carbon was subsequently rinsed with deionized water to remove the acid.

The present exemplary embodiment describes the formation of one form of the invention, other precursor materials as identified elsewhere in this document may be used in place of or in addition to those described in the present described exemplary embodiment.

In another embodiment, the functionalized porous carbon electrode material comprises a porous carbon with a conformal surface coating of nanoscale CuHCF film. After completing the formation of the functionalized porous carbon, the CuHCF film is applied. Porous carbon is produced with functionality includes one or more of O, N, S, P and Ni as a catalyst to seed the electroless deposition of Cu upon the surfaces of the porous carbon. The Cu source is a Cu²⁺ salt, Cu(NO₃)₂ as a low concentration aqueous solution using de-oxygenated de-ionized water, a pH buffer and at least one complexing agent under temperature control using a stirrer. The solution is first vacuum equilibrated then left for a time depending upon the desired film thickness during which the Cu²⁺ ions are reduced on the surface of the functionalized porous carbon to form a Cu metal layer on said porous copper. Once the Cu metal layer is formed, potassium ferrocyanide K₄Fe(CN)₆ solution is added to complete the CuHCF film formation. Alternatively, nanoscale CuHCF deposits and trapped nanopowders within the in porous carbon pores can be created without creating the Cu metal layer by substituting potassium ferricyanide K₃[Fe(CN)₆] solution for the potassium ferrocyanide solution. A solution of copper nitrate or copper sulfate is first vacuum equilibrated into said porous carbon.

In one embodiment, the functionalized porous carbon electrode material comprises a porous carbon with a conformal surface coating of metal oxide wherein said coating is produced by an oxidation/reduction reaction occurring between the metal salt contained in an aqueous precursor solution and the surface of said porous carbon when said porous carbon is infiltrated with said precursor solution; wherein transition metal species contained in said precursor solution are reduced on the surface of the carbon and co-deposited in oxide form upon the carbon; wherein said aqueous precursor solution is maintained at a temperature above about 20° C. and below about 250° C. during said infiltration; wherein an autoclave is the reaction vessel when synthesis temperatures above about 100° C. are used; wherein said infiltration is accomplished by immersion and equilibration of said carbon structure in a bath of said aqueous metal salt precursor solution or by application of pressure spray consisting of said aqueous metal salt precursor solution upon said porous carbon; wherein the solvent of said aqueous metal salt precursor solution shall contain one or more of purified water, an organic solvent such as an alcohol, a pH buffer, additional cation salts or any combination thereof; wherein said aqueous metal salt precursor solution shall comprise one or more salts of metals selected from a group consisting of manganese, nickel, cobalt, iron, aluminum, chromium, molybdenum, rhodium, iridium, osmium, rhenium, vanadium, tungsten, tantalum, palladium, lead, tin, titanium, copper, zinc, niobium and lithium; wherein the electrode material is used as prepared or the counter ions incorporated in the oxide coating are exchanged for other cations or protons; wherein the formed electrode material is used as-prepared or wherein the formed electrode material is heated subsequent to formation of the oxide coating, such heating to occur as hydrothermal processing at temperatures above about 70° C. and below about 250° C. in an autoclave or with the use of microwave radiation or in an oven or furnace at temperatures above about 70° C. and below about 1000° C. in inert atmosphere or in oxidizing atmosphere or in reducing atmosphere or any combination thereof. In one embodiment, said oxidation/reduction reaction between said porous carbon structure and said aqueous metal salt precursor solution occurs while the reactants are exposed to microwave energy. In one embodiment, said aqueous precursor solution shall comprise ultrapure water, or a buffer solution with or without organic co-solvent or additional cations, further comprising one or more metal salt in the form of M(NO_{y})_{z} xH₂O, MCl_{y} xH₂O, MF_{y}, MI_{y}, MBr_{y}, (MCl_{y})_{z} xH₂O, M(ClO_{y})_{z} xH₂O, MF_{y}, M_{y}(SO_{z})_{w}, MSO_{y} xH₂O, M_{y}P, MPO_{y} xH₂O, M(OCH_{y})_{z}, MOSO_{y} xH₂O, M(C_{y}O_{z}) xH₂O, where x is a value greater than or equal to 0 and less than or equal to 12 and y is a value greater than or equal to 0 and less than or equal to 4 and z is a value greater than or equal to 0 and less than or equal to 4 and w is a value greater than or equal to 0 and less than or equal to 4, and M is selected from a group consisting of manganese, nickel, cobalt, iron, aluminum, chromium, molybdenum, rhodium, iridium, osmium, rhenium, vanadium, tungsten, tantalum, palladium, lead, tin, titanium, copper, zinc, niobium and lithium; or NaMnO₄, KMnO₄, LiMnO₄, K₂FeO₄; or titanium(III) chloride tetrahydrofuran complex (1:3), titanium diisopropoxide bis(acetylacetonate), titanium(IV) isoproprxide, titanium(IV) (triethanolaminato) isoproprxide, titanium(IV) bis(ammonium lactato)dihydroxide, titanium(IV) butoxide, titanium(IV) ethoxide, titanium(IV) oxyacetylacetonate, titanium(IV) phthalocyanine dichloride, titanium(IV) propoxide, titanium(IV) sulfide, titanium(IV) tert-butoxide, titanium(IV) 2-ethylhexyloxide, K₂TiF₆, FeSO₄ NH₃CH₂CH₂NH₃SO₄ 4H₂O, Iron(II) acetate, Iron(II) acetylacetonate, ammonium iron(III) oxalate trihydrate, Iron(III) citrate, NaNO₃, KNO₃, LiNO₃, Na₂SO₄, K₂SO₄, Li₂SO₄, NaOH, KOH, LiOH. At synthesis temperatures above about 100° C., an autoclave is used.

The metal oxide coating may comprise water, ions and shall contain one or more metal oxides selected from a group consisting of oxides of manganese, nickel, cobalt, iron, aluminum, chromium, molybdenum, rhodium, iridium, osmium, rhenium, vanadium, tungsten, tantalum, palladium, lead, tin, titanium, copper, zinc, niobium and lithium.

Functionalized porous carbon coated with metal oxide films may be used as-synthesized or the counter ions may be fully exchanged or partially exchanged for a different ion species or for protons. Coated electrode materials may be heated subsequent to formation of the nanoscale oxide coating; such heating to occur as hydrothermal processing at temperatures above about 70° C. and below about 250° C. in an autoclave or with the use of microwave radiation or at temperatures above about 70° C. and below about 1000° C. in inert atmosphere or in oxidizing atmosphere or in reducing atmosphere or any combination thereof. Such ion exchange and heating techniques represent some of the synthetic controls that can be used to create oxide phases suitable to specific applications. For example, xMO₂/C where C is the carbon structure, x is the cation and M is a poorly crystalline birnessite or other phase manganese and/or other oxide formed on the carbon using the synthesis herein at ambient conditions provides a pseudocapacitance-type reaction suitable as cathode material for aqueous electrochemical capacitor applications. In another example, a spinel-type oxide phase/carbon is created by cation exchange for lithium followed by heat treatments following synthesis of the aforementioned poorly crystalline oxide film. The spinel LiM₂O₄/C is formed where M may be manganese with or without dopants or partial substitutions with elements such as nickel, may be used as cathode material suitable for aqueous or non-aqueous electrochemical capacitor applications, or as cathode material for secondary lithium-ion battery applications.

Other oxide coatings for functionalized porous carbon are contemplated such as Li₄M₅O₁₂/C, LiMO₂/C or Li_{28+y}M₂₀O₄₈/C where 0<y<8 and where M may be titanium with or without niobium and/or tantalum and/or vanadium as dopants or partial substitutions as M₂O₇/C or independent oxides as M₂O₅/C. In these cases, the oxide/carbon material may be used as anode material in non-aqueous electrochemical capacitor applications, or as anode material for secondary lithium-ion battery applications.

Another example of metal/oxide coatings for functionalized porous carbon contemplated herein include M₃O₄/C where M may be manganese and/or iron and/or cobalt. In this case, M is cycled between low-valence oxide and metallic states, and may be used as anode material for use in secondary battery applications such as lithium ion. These materials may be synthesized, for example, using permanganates alone and/or nitrates of manganese and/or cobalt. In one embodiment, the permanganate is used as a reducing agent and a source of manganese; cobalt nitrate, for example, may be optionally used with the permanganate as an additional ion source. In the case wherein permanganate is not used, (as in the cobalt case or manganese oxide not using permanganate route) a precursor salt such as a nitrate may be used in an aqueous solution with reducing agents such as an alcohol and/or ammonia at ambient or other temperatures. In the case of Fe₃O₄/C, iron salts such as potassium ferrate and/or iron(III) chloride hexahydrate may be used as precursor materials. In all cases, the MOx/C materials are subsequently heated to temperatures ranging from about 100° C. to about 250° C. as hydrothermal processing in an autoclave or from about 250° C. to about 600° C. in a furnace or oven under inert atmosphere for between 1 and 24 hours. In certain cases, subsequent heating to temperatures ranging from about 100° C. to about 300° C. in air may be required to obtain the desired oxygen stoichiometry. Also, in some cases, lithium may be used as the counter ion prior to heating for the purpose of assisting in templating the desired oxide phase and/or providing a source of lithium that may be appropriate in a lithium ion device. In some cases, the counter-ions may be exchanged for protons prior to or following heating.

### Example I

Fabrication of functionalized porous carbon electrode material; birnessite manganese/nickel oxide film on carbon nanofoam.

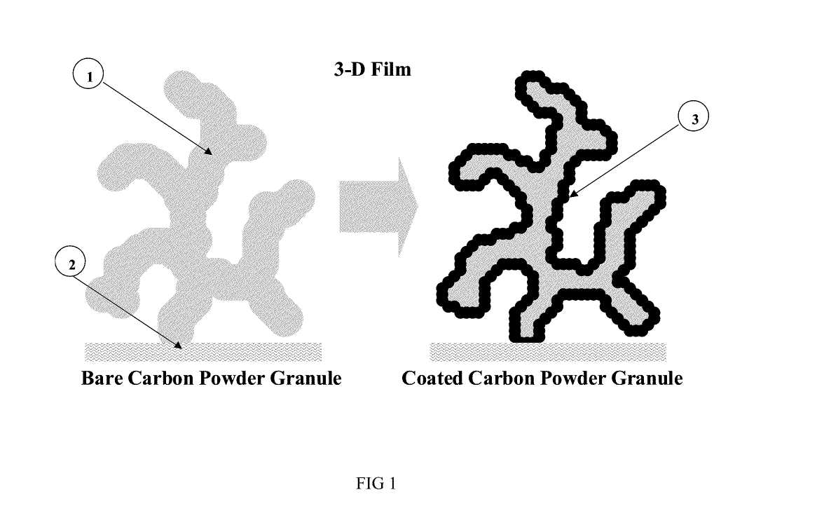

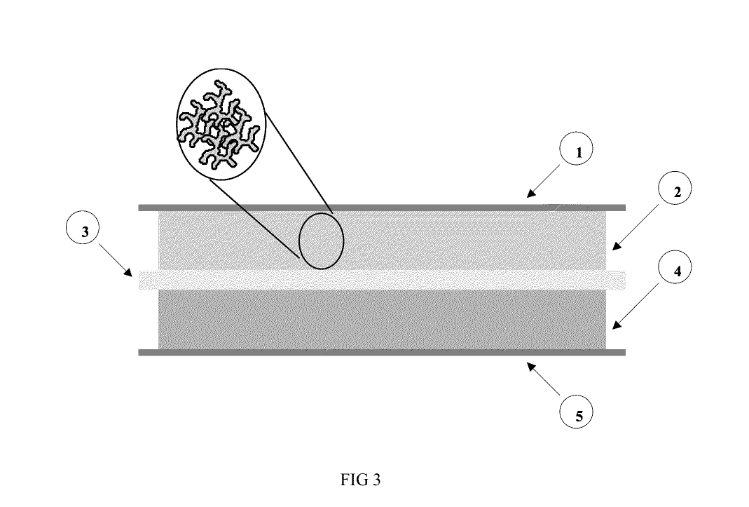

An electrode material as illustrated in FIG. 1 and FIG. 3 was formed by immersing a carbon structure for a controlled period of time in a solution comprising permanganate and nickel salts in a controlled ratio dissolved in ultra-pure water/pH buffer at a controlled pH and temperature. The manganese and nickel from the aqueous permanganate/nickel precursor solution are reduced on the surface of the carbon and co-deposited upon the carbon forming an insoluble oxide film.

Carbon aerogel was purchased from a commercial source (Marketech International Inc.) with an approximate thickness of 170 micrometers. Carbon aerogel paper was cut into pieces of approximately 1 centimeter by 1 centimeter and then soaked and vacuum saturated in purified water.

In this exemplary embodiment, the aqueous metal salt precursor solution comprised manganese/nickel mixture of nickel (II) nitrate hexahydrate (Ni(NO₃)₂ 6H₂O) were normalized to 0.1M sodium permanganate (NaMnO₄, other counter-ion sources may be substituted for sodium (Na) such as potassium (K) or lithium (Li)) and combined with purified water/pH buffer solution of 0.1M NaH₂PO₄ and 0.1M NaOH for neutral pH film synthesis. Another experiment was carried out at an elevated pH of 12 using a buffer solution of 0.05M Na₂HPO₄ and 0.1M NaOH.

The wetted carbon aerogel was then immersed in the precursor solutions, vacuum equilibrated and left immersed for a period of time ranging from approximately 15 minutes to 20 hours. These synthesis processes were carried out at room temperature.

The resulting electrode materials were removed from the precursor solution, rinsed with purified water and dried in a nitrogen environment at 50° C. for 20 hours and again under vacuum at room temperature for an additional 12 hours.

### Example II

### Characterization of electrode material; manganese/nickel oxide film on carbon aerogel

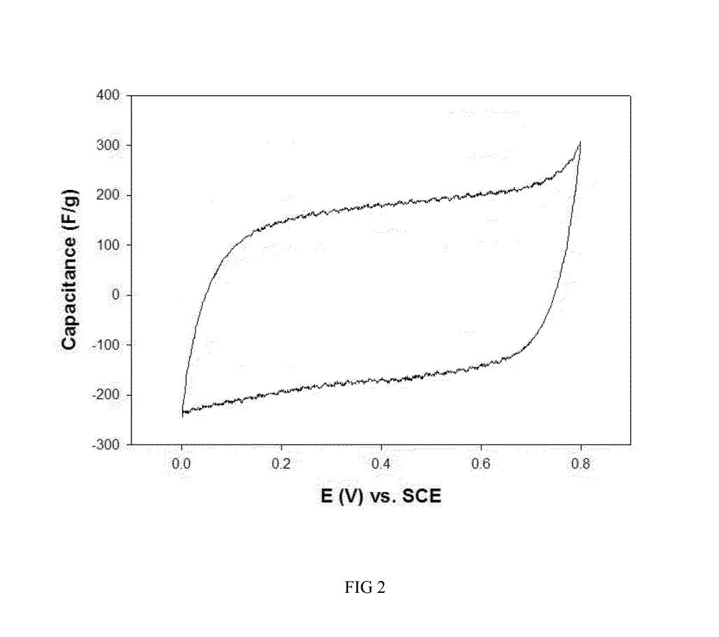

FIG. 2 shows cyclic voltammetry data of a 4:1 manganese/nickel oxide material with capacitance of approximately 180 F/g in 1M LiCl electrolyte.

### Example III

Fabrication of functionalized porous carbon electrode material; nanoscale oxide film comprising spinel manganese doped with nickel on carbon aerogel.

An electrode material is formed as in EXAMPLE I, using a precursor ratio of about 0.99:0.01 manganese:nickel.

Prior to drying, counter ions are exchanged for lithium ions by immersion of the formed electrode in an aqueous solution bearing lithium ions such as lithium nitrate, lithium sulfate or lithium hydroxide, for example. In this exemplary embodiment, lithium nitrate was used. Such immersion is carried out first under vacuum equilibration, then at room temperature or elevated temperature or under microwave heating, for example. In this exemplary embodiment, about 30° C. for about 2-4 hours was used.

The material was subsequently heated to about 300-350° C. under nitrogen atmosphere for about 1-2 hours, followed by heating at about 200-220° C. in air for about 3-6 hours.

### Example IV

Characterization by cyclic voltammetry of electrode; nanoscale oxide film comprising spinel manganese doped with nickel on carbon aerogel.

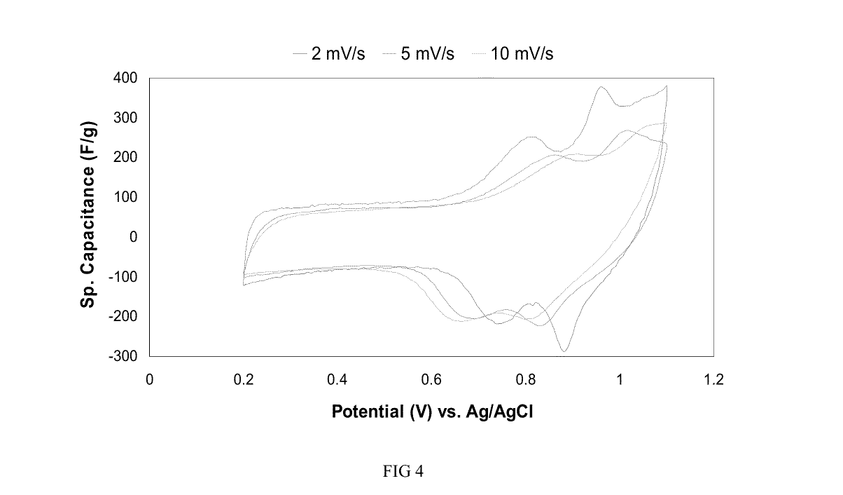

FIG. 4 shows cyclic voltammetry data of nickel doped manganese spinel/carbon material with average capacitance of approximately 200 F/g between about 600 mv and 900 mv vs. Ag/AgCl in 2M Li₂SO₄ electrolyte. Noteworthy are the redox peaks not present in the more disordered birnessite/nickel oxide of examples 1 and 2, indicating the presence of spinel phase in the doped and heated oxide layer.

Although embodiments of the invention have been described, it is understood that the present invention should not be limited to those embodiments, but various changes and modifications can be made by one skilled in the art within the spirit and scope of the invention as hereinafter claimed.

### Example V

Fabrication of functionalized porous carbon electrode material; nanoscale metal oxide film comprising M₃O₄ where M is manganese doped with cobalt on porous carbon.

An electrode material is formed as in EXAMPLE I, using a precursor ratio of about 0.99:0.01 manganese:cobalt.

Prior to drying, counter ions are exchanged for lithium ions by immersion of the formed electrode in an aqueous solution bearing lithium ions such as lithium nitrate, lithium sulfate or lithium hydroxide, for example. In this exemplary embodiment, lithium nitrate was used. Such immersion is carried out first under vacuum equilibration, then at room temperature or elevated temperature or under microwave heating, for example. In this exemplary embodiment, 30° C. for 4 hours was used.

The material was subsequently heated to about 300-350° C. under nitrogen atmosphere for about 1-2 hours followed by removal of ions by proton exchange with dilute acid, subsequent rinsing and drying.

### Example VI

Fabrication of functionalized porous carbon electrode material; carbon doped with nitrogen and phosphorous.

In this example, melamine was used as a source of carbon and to provide dopant nitrogen to increase electron conduction and induce pseudocapacitive functionality, monosodium phosphate was used to provide dopant phosphorous to suppress oxygen evolution in aqueous electrolytes and the sodium as a secondary templating agent, carbon black was used to induce improved electron conduction functionality. Magnesium citrate was used as a precursor to magnesium oxide formed during heating and used as a templating agent, to provide oxygen functionality for pseudocapacitance and as an additional source of carbon.

Precursor materials were 5.35 g of magnesium citrate was combined with 2 g of melamine, 2 g of monosodium phosphate and 100 mg of carbon black. All were in dry powder form and ground mixed by mortar and pestle for 15 minutes to ensure mixture uniformity.

The mixed precursors were placed in a tube furnace and heated to 700° C. under flowing nitrogen atmosphere, and held at that temperature for one hour, then cooled. Heating and cooling were performed at controlled rates of 5° C. per minute.

The resulting carbon was removed from the tube furnace and rinsed with 10 mM HCl to remove magnesium oxide template thereby revealing doped porous carbon. The doped porous carbon was subsequently rinsed with deionized water to remove the HCl.

Electrodes were fabricated using the porous carbon combined with PTFE as a binding agent and carbon black according to ratio 85%:7.5%:7.5% respectively, and rolled to form a free standing film of approximately 150 micrometers thickness.

### Example VII

Characterization of functionalized porous carbon electrode material; carbon doped with nitrogen and phosphorous.

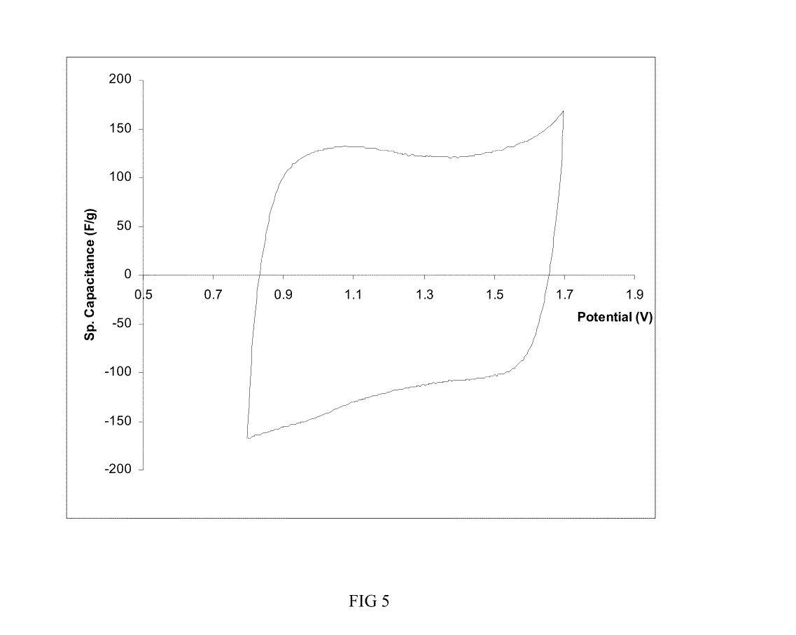

FIG. 5 shows a double-layer and pseudo-capacitance behavior in a cyclic voltammogram for Example 4; magnesium oxide templated, nitrogen and phosphorous doped carbon material at 5 mV/s in 4M ZnCl₂+3M NaCl electrolyte in a Zn/carbon cell.

### Example VIII

Fabrication of functionalized porous carbon electrode material; carbon doped with nitrogen.

In this example, melamine was used as a source of carbon and to provide dopant nitrogen to increase electron conduction and induce pseudocapacitive functionality, glucose-D was used as a carbon source to modify the relative concentration of carbon vs. dopants and to induce oxygen functional groups for pseudocapacitance, carbon black was used to induce improved electron conduction functionality. Magnesium citrate was used as a precursor to magnesium oxide formed during heating and used as a templating agent, to provide oxygen functionality for pseudocapacitance and as an additional source of carbon.

Precursor materials were 5.35 g of magnesium citrate was combined with 2 g of melamine and 100 mg carbon black, all were in dry powder form and mixed by mortar and pestle for 15 minutes to ensure mixture uniformity.

The mixed precursors were placed in a tube furnace and heated to 700° C. under flowing nitrogen atmosphere, and held at that temperature for one hour, then cooled. Heating and cooling were performed at controlled rates of 5° C. per minute.

The resulting carbon was removed from the tube furnace and rinsed with 10 mM HCl to remove magnesium oxide template thereby revealing doped porous carbon. The doped porous carbon was subsequently rinsed with deionized water to remove the HCl.

Electrodes were fabricated using the porous carbon combined with PTFE as a binding agent and carbon black according to ratio 85%:7.5%:7.5% respectively, and rolled to form a free standing film of approximately 150 micrometers thickness.

### Example IX

Characterization of functionalized porous carbon electrode material; carbon doped with nitrogen.

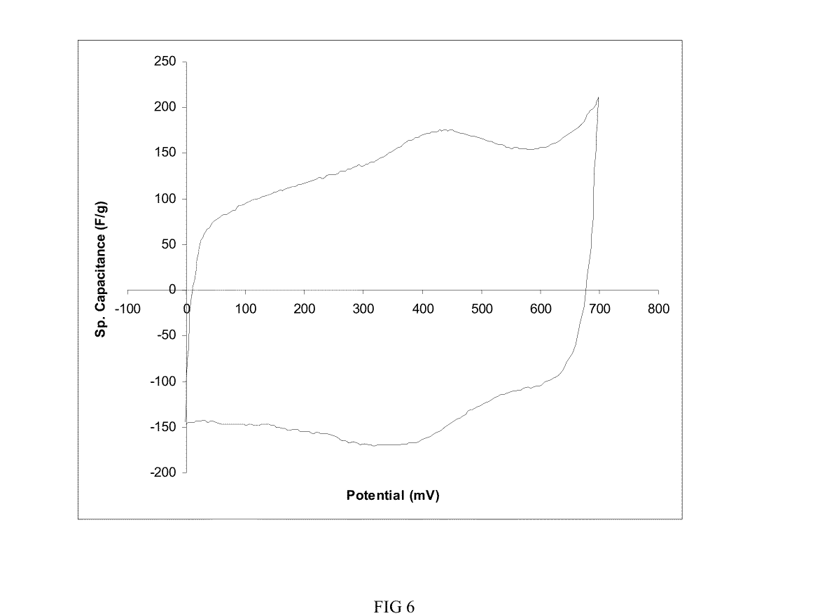

FIG. 6 shows a double-layer and pseudo-capacitance behavior in a cyclic voltammogram for Example 5; magnesium oxide templated, nitrogen doped carbon material at 5 mV/s in 1M Na₂SO₄ electrolyte in a half-cell vs. Ag/AgCl reference.

### Example X

Fabrication of functionalized porous carbon electrode material; nanoscale film comprising CuHCF on porous carbon.

In this example, CuHCF film provides reversible electrochemical storage capacity at a desirable voltage of ca. +1 V vs. SHE. The combination of high surface area film and the electrically conductive substrate of functionalized carbon contribute to decrease hysteresis between anodic/cathodic processes.

Precursor materials are a porous carbon as produced in the preceding examples, where desirable functionality includes one or more of O, N, S, P and Ni as a catalyst to seed the electroless deposition of Cu upon the surfaces of the porous carbon. The Cu source is a Cu²⁺ salt, Cu(NO₃)₂ as a low concentration (less than 100 mM) aqueous solution using de-oxygenated de-ionized water, a pH buffer and at least one complexing agent under temperature control using a stirrer. The solution is first vacuum equilibrated then left for a time depending upon the desired film thickness during which the Cu²⁺ ions are reduced on the surface of the functionalized porous carbon to form a Cu metal layer on said porous copper. Once the Cu metal layer is formed, potassium ferrocyanide K₄Fe(CN)₆ solution is added to complete the CuHCF film formation.

Alternatively, nanoscale CuHCF deposits and trapped nanopowders within the in porous carbon pores can be created without creating the Cu metal layer by substituting potassium ferricyanide K₃[Fe(CN)₆] solution for the potassium ferrocyanide solution. A solution of copper nitrate or copper sulfate is first vacuum equilibrated into said porous carbon.

What is claimed is:

1) A functionalized porous carbon electrode material having a specific surface area greater than about 10 m²/g and less than about 3000 m²/g and the form of a powder wherein the average particle size is greater than about 100 nanometers and smaller than about 100 micrometers in its largest dimension; said porous carbon comprising pores of above average pore size and pores of below average pore size, wherein said pores of above average pore size have an average diameter larger than about two nanometers and wherein pores of below average pore size are smaller than about five micrometers;
wherein the precursor materials for said functionalized carbon comprise at least one carbon-containing compound as a carbon source for synthesized carbon, at least one templating agent, and at least one functionality-inducing agent;
wherein said functionality-inducing agent is incorporated in the form of one or more selected a group consisting of a heteroatom dopant, a physical mixture forming a composite matrix of said synthesized carbon, a deposit upon said carbon surface, or any combination thereof;
wherein at least one precursor source material for said synthesized carbon or doped carbon is at least one selected from a group consisting of an aromatic hydrocarbon, a hydrolyzed benzene, an amine, an aniline, an aldehyde, a dialdehyde, a gelatin compound, a monosaccharide, a disaccharide, a oligosaccharide, a polysaccharide, a thermoplastic polymer, and a thermoplastic fluoropolymer;
wherein said templating agent is at least one compound selected from a group comprising metal-containing compounds wherein each comprises a metal A and material B, or a combination of metal A, material B and at least one cation species,
wherein metal A is selected from a group of consisting of ions of the elements magnesium (Mg), calcium (Ca), sodium (Na), potassium (K), lithium (Li), manganese (Mn), nickel (Ni), cobalt (Co), iron (Fe), aluminum (Al), chromium (Cr), molybdenum (Mo), vanadium (V), tungsten (W), tantalum (Ta), lead (Pb), tin (Sn), titanium (Ti), copper (Cu), zinc (Zn), niobium (Nb), silicon (Si) and any combination thereof;
wherein material B comprises at least one selected from a group consisting of oxygen (O), hydrogen (H), nitrogen (N), phosphorous (P), sulfur (S), carbon (C), fluorine (F) and any combination thereof;
wherein said heteroatom dopant comprises at least one P-block element selected from a group consisting of N, O, F, Si, P, S, boron (B), chlorine (Cl), gallium (Ga), germanium (Ge), selenium (Se), bromine (Br), and iodine (I);
wherein said functionalizing agent incorporated as a composite carbon physical mixture comprises at least one precursor material selected from a group consisting of i) a preformed carbon and ii) an inorganic compound;
wherein said preformed carbon is at least one selected from a group containing carbon microfibers, carbon nanofibers, carbon nanotubes, carbon nanowires, graphene, reduced graphene oxide, graphene oxide, graphite, and carbon black;
wherein said inorganic compound contains material A and material B, or a combination of material A, material B and at least one cation species, wherein material A is selected from a group of consisting of Mn, Ni, Co, Fe, Al, Cr, Mo, V, W, Ta, Pb, Sn, Ti, Cu, Zn, Nb, Si, Na, K, Li, Mg, Ca, and any combination thereof, and material B is selected from a group of consisting of O, H, P, C, N, S and any combination thereof;
wherein said functionalizing agent incorporated as a surface deposit comprises at least one selected from a group comprising metal oxide, electro-active polymer, electro-active polymer which is doped with at least one inorganic species, and transition metal hexacyanometalate;
wherein said metal oxide deposit contains material A and material B, or a combination of material A, material B and at least one cation species, or a combination of material A, material B and at least one cation species and water, wherein material A is at least one selected from a group of consisting of Mn, Ni, Co, Fe, Al, Cr, Mo, V, W, Ta, Pb, Sn, Ti, Cu, Zn, Nb, Si, Na, K, Li, Na, K, Mg, Ca, and any combination thereof, and material B is at least one selected from a group of consisting of O, H, P, C, N, S and any combination thereof;
wherein said electro-active polymer comprises one or more of a redox polymer or a conductive polymer, said electro-active polymer is selected from a group consisting of polypyrrole (PPy), polyaniline (PANI), poly-3,4-ethylenedioxythiophene (PEDOT), poly(o-methoxyaniline) (POMA), poly-1,5-diaminoanthraquinone (PDAAQ), polyquinoxaline (PQ), polyindole (PIn), cyclic indole trimers (CIT), 5-carboxy CIT, 5-cyano CIT, polyacene (PAC), polyacetylene (PA), poly(vinylpyridine) (PVPy), tetramethylpyridine, polythiophene (PT), and derivatives and combinations thereof;
wherein the dopant of said electro-active polymer is at least one element selected from a group consisting of O, H, P, C, N, S, Mn, Ni, Co, Fe, Al, Cr, Mo, V, W, Ta, Pb, Sn, Ti, Cu, Zn, Nb, Na, K, Mg, Ca, and Li;
wherein said transition metal hexacyanometalate takes the form A^{va}ₐ (M₁^{v1})_{b} [M₂^{v2}(CN)_{c}]_{d}*xH₂O, where “A” is an insertion cation of valence “va” of an alkali metal, an alkaline earth metal or ammonium, where “M₁” is a metal ion of valence “v1”, where M₂ is a metal ion of valence “v2”, where “a”, “b”, “c”, and “d” represent stoichiometry of the complex, and where “x” represents the stoichiometry of coordinated water molecules, where M₁ is at least one element selected from a group consisting of Mn, Ni, Co, Fe, Al, Cr, Mo, V, W, Ta, Pb, Sn, Ti, Cu, Zn, and Nb, where M₂ is least one element selected from a group consisting of Mn, Ni, Co, Fe, Al, Cr, Mo, V, W, Ta, Pb, Sn, Ti, Cu, Zn, and Nb;
wherein the average thickness of said surface deposit is greater than about 5 nanometers and less than about 1000 nanometers.

2) An electrochemical cell having at least one electrode comprising the material of claim 1, further comprising:
an electrolyte,
an electronically insulating but ionically conductive separator film,
a pair of electrodes or in the case of a device using electrodeposition and dissolution processes as anode functionality, an electrode and an anode deposition substrate (ADS) separated by said separator and electrolyte, each electrode or electrode/ADS combination is physically attached and electronically connected to a current collector;
wherein said electrolyte comprises at least one cation species, at least one anion species, and comprises at least one composition selected from a group consisting of ionic liquid, salt and polymer, salt and ceramic, salt and liquid solvent and polymer as a gel, salt and liquid solvent and fumed silica as a gel, and salt and liquid solvent, the liquid solvent comprises at least one selected from a group consisting of water and aprotic liquid;
wherein the second electrode, if not an functionalized carbon electrode material as defined herein, is one or more selected from a group consisting of electrodeposited metal, metal oxide, metal phosphates, metal carbides, metal nitrides, a composite carbonaceous paste comprising powder of one or more selected from a list consisting of
activated carbon, carbon nanofibers, carbon nanotubes, graphene, reduced graphene oxide, graphite or any combination thereof, with binder and conductivity enhancing carbon,
a composite carbonaceous paste comprising
graphitic carbon powder, hard carbon powder, metal oxide/carbon composites, silicon/carbon composites or any combination thereof with binder and conductivity enhancing carbon, or a porous carbon structure;
wherein the current collector is selected from a group consisting of metal foil, graphite foil, metal mesh, electrically conductive polymer composites, expanded metal, or any combination thereof.
